(19) United States
(12) Patent Application Publication
(10) Pub. No.: US 2023/0189804 A1
(43) Pub. Date: Jun. 22, 2023

(54) PROHEXADIONE PLANT GROWTH REGULATOR COMPOSITION

(71) Applicant: Nufarm Americas, Inc., Aslip, IL (US)

(72) Inventor: Robert Underhile, Aslip, IL (US)

(21) Appl. No.: 18/067,894

(22) Filed: Dec. 19, 2022

Related U.S. Application Data
(60) Provisional application No. 63/292,556, filed on Dec. 22, 2021.

(51) Int. Cl. A01N 37/42; A01N 25/04; A01N 59/00; A01N 25/22; A01N 25/30; A01P 21/00

(52) U.S. Cl. CPC A01N 37/42; A01N 25/04; A01N 59/00; A01N 25/22; A01N 25/30; A01P 21/00

(57) ABSTRACT

An aqueous suspension concentrate composition of prohexadione comprising prohexadione-calcium, ammonium sulfate and an amine.

### FIELD

The invention relates to an aqueous suspension concentrate of the plant growth regulator prohexadione and to a method of preparation and use on prohexadione in control of weeds.

### Background

Prohexadione calcium (IUPAC name: calcium 3,5-dioxo-4-propionyloyclohexanecarboxylic acid (CA): calcium 3,5-dioxo-4-(1-oxopropyl)cyclohexanecarboxylate), Prohexadione calcium is a foliar applied plant regulator which reduces vegetative growth by inhibiting the synthesis of gibberellin, a naturally occurring plant hormone, resulting in reduced internode length and vegetative growth. Prohexadione-calcium is used, for example in inhibiting plant growth in cereals crops including barley, oats and wheat; and also in turf; apples; pears, cherries and Peanuts It is sprayed on apple and pear leaves, to provide enhanced resistance of apple and pear leaves toward two major diseases, fire blight (caused by Erwina amylovora) and apple scab (caused by Venturia inaequalis)

Prohexadione calcium is available as a dry flowable compositions. The dry flowable compositions such as water dispersible granules are often mixed with ammonium sulfate in the spray tank to improve the activity of the composition and reduce problems in mixing with hard water in the spray tank. The end user of the dry flowable formulation is required to mix and effectively dispersed in the dry flowable in water and the diluted composition is typically applied with spray equipment to leaf surfaces. Ineffective dispersion of the dry flowable or the use of a hard water source can lead to settling of the product or blocking of spray nozzles with the risk of resultant underdosing

The solubility of prohexadione calcium is about 786 mg/I in distilled water at 20° C. and it is prone to degrade over time in aqueous composition. Prohexadione calcium has a reported hydrolysis rates of 4.4 to 65 days at pH of 5 to 7 and contains chromophores that absorb at wavelengths >290 nm and, therefore, may be susceptible to direct photolysis by sunlight (Pesticide Manual 15^{th} edition ver. 5.1 Alton British Crop Protection Counsel).

Accordingly, while customers often prefer liquid formulations over dry flowable compositions for ease of handling, dilution in a spray tank and reduced hazards from dusts, there is a need for a suspension concentrate compositions of prohexadione-calcium.

### SUMMARY

We have found that prohexadione-calcium can be formulated in a stable aqueous suspension concentrate in the presence of and ammonium sulfate and an organic amine proton scavenger.

We provide an aqueous suspension concentrate composition of prohexadione comprising prohexadione-calcium, ammonium sulfate and an amine. The amine preferably has a water solubility of at least 4g/L at 20° C.

The composition of the invention provides the significant advantage of including ammonium sulfate in a liquid composition containing prohexadione-calcium which exhibits excellent storage stability. The composition provides the enhanced activity afforded by ammonium sulfate without the requirement to handle solid powder or granules and without the need for in-tank mixing of ammonium sulfate prior to use in the field.

The organic amine may be a primary, secondary or tertiary amine and may be a hindered amine such as DABCO.

In one embodiment the amine comprises at least one of formula (I)

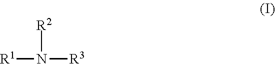

wherein R¹, R² and R³ are independently selected from the group consisting of hydrogen, C₁ to C₆ alkyl; aryl; C₁ to C6 alkyl substituted with a substituent selected from the group consisting of hydroxyl, C₁ to C6 alkoxy, amino, C₁ to C6 alkylamino, amino-substituted alkylamino, amino-substituted C₁ to C6 alkoxy and di-(C₁ to C6 alkyl)amino; and wherein at least one of R₁, R₂ and R₃ is other than hydrogen; and the group wherein two of R¹, R² and R³ together form a ring, incorporating the amine nitrogen, of 5 or 6 constituent ring members selected from the group consisting of methylene and optionally a further heteroatom ring member (in addition to the amine nitrogen) selected from —O—, oxo (C═O) —N(H)— and —N(C₁ to C₆-alkyl)-; and the other of R¹, R² and R³ is selected from hydrogen, C₁ to C₆ alkyl and C₁ to C₆ alkyl substituted with a substituent selected from the group consisting of hydroxyl, C₁ to C₆ alkoxy, amino and amino-(C₁ to C₆ alkyl).

Preferred amines of formula I include those where R1, R2 and R3 are independently selected from the group consisting of hydrogen, C1 to C6 alkyl; Cl to C6 alkyl substituted with a substituent selected from the group consisting of hydroxyl, Cl to C6 alkoxy, amino, C1 to C6 alkylamino, amino-substituted alkylamino, amino substituted C1 to C6 alkoxy and di-(C1 to C6 alkyl)amino; and wherein at least one of R1, R2 and R3 is other than hydrogen.

In one set of embodiments the amine is of formula I wherein R¹, R² and R³ are independently selected from the group selected from hydrogen and C₁ to C₆ alkyl wherein at least one of R¹, R² and R³ is C₁ to C₆ alkyl. Preferred amines in this group are mono-, di- and tri-(C₁ to C₆ alkyl)amines and preferably tri-(C₁ to C₄ alkyl)amines such as triethylamine. Specific examples of amines in this group include dimethylamine, trimethylamine, ethylamine and triethylamine.

In a further set of amines of formula I R¹, R² and R³ are independently selected from the group consisting of hydrogen, C₁ to C₆ alkyl and C₁ to C₆ alkyl substituted with a substituent selected from the group consisting of hydroxyl, C₁ to C₆ alkoxy, amino, C₁ to C6 alkylamino, amino-substituted alkylamino, amino-substituted C₁ to C6 alkoxy (C₁ to C₆ alkyl)amino and di-(C₁ to C₆ alkyl)amino wherein at least one of Rⁱ, R² and R³ is other than hydrogen and C₁ to C₆ alkyl. More specific examples of this group of compounds include C₁ to C ₆ alkanolamines, di-(C₁ to C₆ alkanol)amines, tri-(C₁ to C₆ alkanol)amines, di-(C₁ to C₆ alkyl)-C₁ to C₆ alkanolamines, (amino C₁ to C₆ alkyl)-di-(C₁ to C₆ alkyl)amines, di-(amino C₁ to C₆ alkyl)(C₁ to C₆ alkyl)amines, diamino C₂ to C₆ alkyl, amino-(C₁ to C₄ alkoxy)-(C₂ to C₄ alkyl)amines. In this preferred group such compounds as ethanolamine, dimethyl ethanolamine di-ethanolamine, di-isopropanolamine, tri-ethanolamine, tri-isopropanolamine and ethylene-diamine (Ethane-1,2-diamine) are particularly preferred.

In one embodiment two of R¹, R² and R³ together form a ring, incorporating the amine nitrogen, of 5 or 6 constituent ring members selected from the group consisting of methylene and optionally a further heteroatom ring member (in addition to the amine nitrogen) selected from —O—, —N(H)— and —N(C₁ to C₆-alkyl)-; and the other of R¹,R² and R³ is selected from hydrogen, C₁ to C₆ alkyl and C₁ to C₆ alkyl substituted with a substituent selected from the group consisting of hydroxyl, C₁ to C₆ alkoxy, amino and (C₁ to C₆ alkyl)amino. Examples of amines in this group include morpholine and oxazolidone. It will be understood that certain carbamates such as oxazolidone are formed in solution from ethanolamine with addition of carbon dioxide.

In a further set of embodiments R1 is aryl and R2 and R3 are selected from hydrogen and C₁ to C4 alkyl.

Examples of the preferred amines include ethanolamine, dimethyl ethanolamine, diethanolamine, diisopropanolamine, triethanolamine, triisopropanolamine and 2-amino-2-methyl-1-propanol. The most preferred amine is triethanolamine

The composition may, and generally will comprise adjuvants such as surfactants.

The composition typically includes a dispersant. Typically, dispersant may be present in the composition in an amount of up to 80 g/L of suspension concentrate composition such as 0.5 to 60 g/L of composition.

In a further embodiment the invention provides a method of preparing a spray mixture comprising diluting the aqueous suspension concentrate composition of prohexadione with water.

In yet another embodiment the invention provides a method of regulating plant growth comprising applying the aqueous suspension concentrate composition of prohexadione, optionally following dilution the plant foliage.

### DETAILED DESCRIPTION

Where the terms “comprise”, “comprises”, “comprised” or “comprising” are used in this specification (including the claims) they are to be interpreted as specifying the presence of the stated features, integers, steps or components, but not precluding the presence of one or more other features, integers, steps or components, or group thereof.

The term “wt %” refers to mass percent, typically mass percent of the suspension concentrate unless otherwise indicated.

The term “non-volatile,” as used herein, unless otherwise specified, refers to those materials that are liquid under ambient conditions and which have no significant vapor pressure at 20° C., and an average boiling point typically greater than about 200° C.

In one set of embodiments the amine is present in the composition in an amount to provide a pH of the composition in the range of 7.5 to 9.5, preferably in the range of 7.5 to 9 such as 7.8 to 9.0, 7.8 to 8.5 and most preferably about 8.

The presence of the amine allows an aqueous suspension concentrate of prohexadione-calcium, to be formulated with the activity enhancing ammonium sulfate. in the same composition with the significant convenience and safety of an aqueous composition. The amine preferably has a water solubility of at least 4g/L at 20° C.

The aqueous suspension concentrate composition may comprise prohexadione-calcium in an amount of at least 5 wt %, preferably at least 6 wt % such as at least 7 wt % or at least 8 wt %. In some embodiments the amount of prohexadione-calcium is in the range of 5 wt % to 30 wt % preferably 5 wt % to 15 wt % such as 7 wt % to 15 wt %, 8 wt % to 15 wt % or about 10 wt %.

The weight ratio of ammonium sulfate to prohexadione-calcium may be from 3:1 to 1:1, preferably 2.5:1 to 1:1 such as about 2.5 to 1.5 to about 2:1.

The weight ratio of prohexadione-calcium : amine is preferably in the range of 10: 1 to 1:1, preferably 8:1 to 2:1 such as 7:1 to 3:1 or about 5:1.

Typically, the amount of amine is in the range of 0.1 wt % to 10 wt %, preferably 0.5 wt % to 5 wt % such as about 1 wt % to about 5 wt %.

In one embodiment the composition comprises:

5 wt % to 15 wt % prohexadione-calcium;

a weight ratio of ammonium sulfate to prohexadione sulfate in the range of 6:1 to 1:1; and

a non-volatile amine in an amount of from 0.5 wt % to 5 wt %.

The composition will preferably comprise a surfactant component comprising one or more surfactants.

In a further embodiment the aqueous suspension concentrate composition comprises:

5 wt % to 15 wt % (preferably 7 wt % to 15 wt %) prohexadione-calcium;

10 wt % to 30 wt % ammonium sulfate;

0.5 wt % to 5 wt % amine, preferably triethanolamine; and

2 wt % to 20 wt % surfactants.

Surfactants may include dispersants and wetting agents. In some embodiments, a dispersant or wetting agent are selected from organosilicones, alkylpolyoxyethylene ethers, alkylphenol ethoxylate and alcohol alkoxylate surfactants; fatty acid, fatty ester and fatty amine ethoxylates, sorbitan and ethoxylated sorbitan esters; ethoxylated vegetable oils, alkyl, glycol and glycerol esters and glycol ethers; tristyrylphenol ethoxylates; copolymers of glycerol, a dicarboxylic acid and a monocarboxylic acid; and glucamides.

The surfactant component of the composition preferably includes a dispersant. Examples of dispersants include lignosulfonates, naphthalene sulfonate condensates, sulphates and phosphates of polyarylphenol ethoxylates, polyaryl ether sulfates and phosphates, polycarboxylates and salts thereof, esters (particularly trimerate esters) of alkoxylated di(C₁ to C4 alkyl)diethanolamine and comb-graft polymer dispersant.

In one set of embodiments the dispersant comprises a naphthalene sulfonate condensate such as a sodium salt of alkylnaphthalene sulfonate-formaldehyde condensate, for example the sodium salt of methyl naphthalene sulfonate acid-formaldehyde condensate. A further example of a dispersing agent is a naphthalene sulphonate condensate, for example sodium alkylnaphthalene sulfonate-formaldehyde condensate (e.g., Morwet® D425).

A further group of dispersants are selected from sulphates and phosphates of polyarylphenol ethoxylates. These sulphates and phosphates may be in their acid forms, or as salts, such as the ammonium salt or amine salt such as the triethanolamine salt. Examples of such products include: Soprophor BSU', ‘Soprophor S25’, Soprophor TS/10, Soprophor 4D384, Soprophor 3D33, Soprophor FL.

The dispersant may comprise at least one selected from the group of polyaryl ether sulfates and phosphates. For example, excellent storage stability is provided by ethoxylated tristyrylphenol sulfates such as, for example, ethoxylated tristyrylphenol sulphate such as 2,4,6-Tris [1-(phenyl) ethyl] phenyl-omega-hydroxypoly(oxyethylene) sulphate (Soprophor® 4D384), and ethoxylated tristyrylphenol phosphate such as polyethylene glycol 2,4,6-tristyrylphenyl ether phosphate triethanolamine salt (Soprophor® FL). In one embodiment of the aqueous suspension concentrate the second surfactant component comprises a sulphated or phosphated di- or tristyrenephenol ethoxylate.

A further example of a dispersant component comprises ethoxylated tristyrenephenol sulfate, such as, for example, Soprophor® FL or ethoxylated tristyrylphenol sulphate, for example 2,4,6-Tris [1-(phenyl) ethyl] phenyl-omega-hydroxypoly(oxyethylene) sulphate (Soprophor® 4D384).

In one embodiment the dispersant comprises a salt of polyarlyether sulfate and/or phosphate such as an ammonium salt of tristyryl ether sulfate.

In one set of embodiments the dispersant of the suspension concentrate composition comprises a polycarboxylate or a salt thereof, Polycarboxylates include acrylic and/or methacrylic acid polymers, and reaction products of unsaturated diacid or diacid derivatives and linear or branched alkenes such as polycarboxylates having a molecular weight in the range of about 600 to about 12,000. Examples of polycarboxylate surfactants include Geropon T/36, which is a reaction product of maleic anhydride and 2,4,4 trimethylpentene.

The dispersant in one set of embodiments is selected from esters (particularly trimerate esters) of alkoxylated di(C₁ to C₄ alkyl)diethanolamine such as trimerate esters of alkoxylated diethylethanolamine (such as alkoxylated diethylethanolamine mono-trimerate) including polyoxyethylene (12) di-ethyl ethanolamine mono-trimerate. An example of such an amphoteric polymer surfactant is available under the trade name AtIox™ 4915. The amount of polymeric amphoteric surfactant, preferably alkoxylated diethylethanolamine mono-trimerate such as polyoxyethylene (12) di-ethyl ethanolamine mono-trimerate, is preferably 10 to 80 g/L concentrate, more preferably from 20 g/L to 80 g/L.

The dispersant may comprise a comb-graft polymer dispersant, which may also function as a wetting agent. A comb-graft polymer is a material that has polymer or oligomer chains of one chemical composition branching out from a polymer backbone with a different chemical composition. The preferred comb-graft polymer surfactant for use in the present invention has a polymer backbone and polyether groups appended to the polymer backbone. Comb-graft polymers that can be used in accordance with this invention include but are not limited to, (meth)acrylic acid, (meth)acrylate or methyl (meth)acrylate polymers which have chains of another polymer, as for example, a polyether such as polyethylene glycol, extending from the (meth)acrylate polymer backbone.

In one set of embodiments the comb-graft polymer has a polymer backbone formed of polymers such as (meth)acrylic acid, acrylate, (meth)acrylate or methyl (meth)acrylate polymers and copolymers and polyethylene glycol (PEG) branches extending from this backbone. In two-dimensional representations, the PEG branches are drawn perpendicular to the acrylate polymer backbone (usually linear) and resemble the teeth of a comb, giving rise to the description “comb-graft polymer”. The comb-graft polymers are proprietary materials; therefore, specific details of their composition and manufacture are not known to the applicants.

Suitable comb-graft polymers include but are not limited to Tersperse™. 2500 (about a 35% comb-graft copolymer solution from Huntsman Corp.), Ethacryl PTM. (a 35-45% comb-graft copolymer solution from Lyondell Chemical Co.), and the like.

The composition may comprise one or more thickeners to provide the concentrate with a suitable viscosity such as a viscosity in the range of from 200 cP to 1500 cP (Brookfield viscosity measured using Spindle 2 at 20 RPM and room temperature such as 20° C.). Examples of thickeners include polysaccharides such as xanthan gum, rhamsan gum, locust bean gum, carrageenan or welan gum; a synthetic polymer such as sodium polyacrylate; a semisynthetic polysaccharide such as carboxy methyl cellulose; a mineral fine powder such as aluminum magnesium silicate, smectite, bentonite, hectorite or fumed silica, or alumina sol. The amount of the thickener to be used in the suspension of the present invention is usually from 0.01 wt. % or more, preferably 0.05 wt. % or more, and typically at the same time 5.0 wt. % or less, and preferably 1.0 wt. % or less, with wt. % based on weight of the pesticide suspension concentrate composition. The amount of thickener is generally about 0.1g/L to 20 g/L.

In one embodiment an inorganic thickener such as smectite clay is used at 3-25 g/L, preferably 3 g/L to 15 g/L and more preferably 8 g/L to 12 g/L. In a preferred embodiment an organic thickener, such as xanthan gum, is used at 0.5 g/L to 10 g/L , preferably 0.5 g/L to 5 g/L such as 1 g/L to 2.5 g/L.

The composition may and typically will include other additives such as preservative and antifoam. Preferred preservative agents can be used in accordance to some embodiments of the present invention include, for example, 1,2-benzisothiazolin-3-one available commercially as Proxel GXL (tradename, Zeneca AG). The amount of the antiseptic to be used in the suspension of the present invention is usually from 0.01 wt. % or more, preferably 0.05 wt. % or more, and at the same time 1.0 wt. % or less, and preferably 0.3 wt. % or less, with wt. % based on the weight of the pesticide suspension concentration formulation. Typically, the amount is about 0.5 g/L to about 8 g/L , preferably 1.5 g/L to 4 g/L.

Examples of preferred dispersants which may be used in the composition of the invention include copolymers of glycerol, a dicarboxylic acid and a monocarboxylic add. Surfactants of this type are described in US20090156407. A preferred surfactant of this type is a copolymer of glycerol, phthalic acid anhydride and coconut fatty acid. A commercially available example of the preferred dispersant is available from Clariant under the trade name “Synergen GL 5” and comprises approx. 70% of the surfactant copolymer in water such and has an HLB of about 18.

The surfactant preferably also comprises a non-ionic wetting agent. A wide range of alkoxylate wetting agents are known and commercially available. A preferred wetting agent for use in the composition of the invention is a glucamide in aqueous/glycolic solution such as capryloyl/caproyl methyl glucamide.

More preferably, the compositions of the invention comprise, as component e), a mixture of octyl-N-methylglucamide and decyl-N-methylglucamide. This product is obtainable under the Synergen® GA name from Clariant. The proportion of octyl-N-methylglucamide in this mixture may be 10% to 90% by weight, preferably 20% to 80% by weight and more preferably 30% to 70% by weight, based on the total amount of the alkylglucamides present in this mixture. The proportion of decyl-N-methylglucamide in this mixture may be 10% to 90% by weight, preferably 20% to 80% by weight and more preferably 30% to 70% by weight, based on the total amount of the alkylglucamides present in this mixture.

The composition may be prepared by milling of prohexadione-calcium particulate material, preferably with a mixture of dissolved ammonium sulfate, water, amine, dispersant and optionally other components, to reduce the particle size of the prohexadione-calcium to provide a d90 of no more than 10 microns, preferably a d90 of no more than 8 microns. The d90 particle size of prohexadione-calcium in the composition may, for example, be in the range of 2 microns to 10 microns, preferably 2 microns to 8 microns such as 5 microns to 8 microns. Air milling of prohexadione-calcium may also be used as an alternative to wet milling.

In one embodiment the composition contains 0.5 wt % to 10 wt % (such as 0.5 wt % to 5 wt %) of a surfactant which is selected from copolymers of glycerol, a dicarboxylic acid and a monocarboxylic acid. Particularly preferred are copolymers of glycerol, phthalic acid anhydride and coconut fatty acid.

In one embodiment the composition may comprise 0.5 to 10 wt % glucamide surfactant such as 0.5 wt % to 5 wt % glucamide surfactant.

Accordingly, in one embodiment of the aqueous prohexadione composition the composition comprises:

5 wt % to 15 wt % prohexadione-calcium;

10 wt % to 30 wt % ammonium sulfate;

0.5 wt % to 5 wt % amine, preferably triethanolamine; and

0.5 wt % to 10 wt % such as 0.5 wt % to 5 wt % surfactant which is a copolymer of glycerol, a dicarboxylic acid and a monocarboxylic acid; and

0.5 wt % to 10 wt % glucamide surfactant such as 0.5 wt % to 5 wt % glucamide surfactant.

The composition may comprise a wetter surfactant. Preferred wetter surfactants include non-ionic polyglycol ether derivatives of aliphatic alcohols of from 8 to 18 carbon atoms in the aliphatic group. The more preferred surfactants have an HLB in the range of 5 to 14, still more preferably 9 to 14. One example of useful surfactants is the ethoxylated fatty alcohols of 8 to 18 carbon atoms with from 2 to 15E0 units. Specific examples include iso-tridecyl alcohol polyglycol ethoxylates with 2, 5, 6, 8, or 15 moles of ethoxylation Commercially available surfactants of this type include the “Genapol” X020, Genapol X050, Genapol X060, Genapol X080, Genapol X090, Genapol X100 and Genapol X150 respectively. The surfactants have an HLB in the range of 5 to 14, Genapol X050, Genapol X060 and Genapol X080 which include surfactants based on Isodecyl alcohol ethoxylated with 5 EO to 10 EO units and having an HLB in the range of 9 to 14.

We have found that some prohexadione-calcium compositions are prone to the formation of calcium salt precipitates on storage or on formulation with water-containing calcium salts such as calcium chloride, which are commonly present in municipal water sources as a result of water treatment. We have found that chelating agents provide a significant improvement in storage and handling of the suspension concentrate composition by reducing the propensity for formation of calcium salts during storage of field use of the composition. Dilution of the concentrate by the end user such as a farmer, may involve the use of water of variable quality and mineral content. The use of chelating agents has also been found to significantly improve stability in this context. The content of chelating agent is typically in the range of 0.5 wt % to 8 wt % of the concentrate and preferable from 0.5 wt % to 5 wt %. Specific examples of chelating agents include EDTA and its salts such as the disodiurn salt, amine-polycarboxylates, glucuronates, nitrilotriacetic acid (NTA) and its salts such as the trisodium salt and methylglycine diacetic acid (MGDA) and its salts, particularly the trisodium salt of methylglycine diacetic acid (MGDA-Na₃). The most preferred chelating agent is methylglycine diacetic acid (MGDA) and its salts, particularly the trisodium salt of methylglycine diacetic acid (MGDA-Na3). MGDA-Na₃ in amounts of 0.5 wt % to 8 wt % of the concentrate is preferable particularly from 0.5 wt % to 5 wt %. MGDA-Na₃is commercially available from Nouryon of The Netherlands under the trademarks DISSOLVINE® M-40 and DSSOLVNE® M-S.

The composition may contain an odour masking agent to reduce the odour from an amine such as triethanolamine. Examples of odour masking agents include a mixture of 30-70 wt % nonylphenol polyethylene glycol ether, 20-40 wt % methyl salicylate in 10-30 wt % polyethylene glycol.

The composition may comprise an antifreeze agent. Propylene glycol is an exemplary antifreeze agent. Glycerin is another exemplary antifreeze agent. The amount of antifreeze agent is typically about 2 wt % to 10 wt % such as 5 wt % to 8 wt % of the composition.

Typically, the content of water-soluble organic solvents is no more than 10 wt % such as no more than 5 wt % of the composition. The water solubility of the organic solvent will typically avow a single phase of the composition at 20° C.,

The composition may comprise antifoam agent such as a modified silicane antifoam such as polydimethylsiloxane emulsion which is believed to contain siloxanesiol alkyleneoxide copolymer. Such an antifoam is available under the tradename SAG 1572 from Momentive.lnc.

The invention further provides a method of regulating the growth of plants by foliar application of the composition, optionally following dilution. Preferred plants are fruit trees (especially apple, pear and sweet cherry), grarnineae (in particular wheat, triticella, barley, oats and rye, but also maize, rice, sugarcane and turf grass). Other suitable plants are cotton, soybeans, millet, sunflowers, oilseed rape, peanuts, coffee, rice, ornamental plants, lawn grasses (such as Kentucky bluegrass, annual and perennial Ryegras, Tall Fescue, red fescue, white ostrich grass, annual Bluegrass, Zoysia, Berrnude, Centopide, St. Augustine).

Advantages of the present invention is that it allows the combination of prohexadione calcium with ammonium sulfate in an aqueous formulation.

The aqueous composition is typically diluted with water prior to spray application. Following dilution, the composition may be sprayed at rates of 50 ppm Prohexadione calcium active ingredient (ai) to 1000 ppm ai in vigorous trees to provide excellent control of vegetative growth. The optimum rate of Prohexadione calcium ai required to provide effective control of vegetative growth depends on plant vigour, age, training system, crop load, and other factors that influence vegetative growth. Rates of 50 ppm ai to 500 ppm ai have typically been sufficient to provide effective vegetative control.

The invention will now be described with reference to the examples which are provided for the purpose of further understanding embodiments of the invention but are not intended to limit the scope or applicability of the invention to the specific examples.

### EXAMPLES

### Example 1

### Part 1 Prohexadione-Calcium Suspension Concentrate

A suspension concentrate was prepared by combining the components shown in Table 1 in the amounts listed

General methodology: Add water, ammonium sulfate, base, surfactant, and active. Transfer contents to a mill and grind the material until particle size distribution is less than 8 micron. Remove from the mill and perform let down adding gelling agent, antifoam and water.

TABLE 1

| Component | Role | Amount (% w/w) |
|---|---|---|
| Prohexadione-Ca | active | 10.64 |
| Ammonium Sulfate (AMS) | enhancer | 20.00 |
| Synergen ® GL 5 | Dispersant surfactant | 4.00 |
| Synergen ® GA | Wetter surfactant | 5.00 |
| Propylene glycol | Solvent/antifreeze | 6.00 |
| Kelzan polysaccharide | thickener | 0.27 |
| Sag 1572 | defoamer | 1.00 |
| Proxel ® BN | preservative | 0.31 |
| Triethanolamine (TEOA) | Proton scavenger | 3.83 |
| Agromex ® WG 28 | Odour mask | 0.33 |
| water | | 48.63 |
| TOTAL | | 100.00 |

Synergene® GL 5 is a copolymer of glycerol/coconut fatty acid/phthalic acid anhydride of Clariant
Synergene® GA is a glucamide in aqueous/glycolic solution [1-deoxy-1 (methyl-C8-10(even)-alkanoyl)amino)-D-glucitol]
Kelzan is a xanthan gum polysaccharide
Sag 1572—polydimethylsiloxane emulsion—siloxanesiol alkyleneoxide copolymer
Proxel® BN—aqeous dispersion of 13.5% 1,2-benzisothiazolin-3-one (BIT) and 6.5% 2-brromo-2-nitropan-1,3-diol
Aromex® WG 28-30-70% nonylphenol polyethylene glycol ether and 20-40% methyl salicylate in 10-30% polyethylene glycol.

Composition Examples 2-6 Compositions in accordance with the invention were prepared in accordance with Example 1 using the components in the amounts by weight shown in the following Table 2.

TABLE 2

| | Example 2 | Example 3 | Example 4 | Example 5 | Example 6 |
|---|---|---|---|---|---|
| | Amounts | Amounts | Amounts | Amounts | Amounts |
| Component | (% w/w) | (% w/w) | (% w/w) | (% w/w) | (% w/w) |
| Prohexadione-Ca | 10.67 | 10.94 | 10.99 | 10.51 | 10.67 |
| Ammonium | 20.06 | 20.58 | 20.67 | 19.76 | 20.05 |
| Sulfate (AMS) | | | | | |
| Synergen ® GL 5 | 4.02 | 4.12 | 4.13 | 3.95 | 4.01 |
| Synergen ® GA | 5.02 | 5.15 | 5.17 | 4.94 | 5.01 |
| Propylene glycol | 6.02 | 6.17 | 6.20 | 5.93 | 6.02 |
| Kelzan | 0.28 | 0.29 | 0.29 | 0.28 | 0.28 |
| polysaccharide | | | | | |
| Sag 1572 | 1.00 | 1.03 | 1.03 | 0.99 | 1.01 |
| Proxel ® BN | 0.39 | 0.41 | 0.41 | 0.40 | 0.41 |
| amine | 2.00 MIPA | 3.13 TEOA | 2.53 TEOA | 3.47 TEOA | 2.01 AMP 95 |
| Agromex ® WG 28 | 0.26 | 0.27 | 0.27 | 0.26 | — |
| water | 50.29 | 47.91 | 48.3 | 49.52 | 50.27 |
| TOTAL | 100.00 | 100.00 | 100.00 | 100.00 | 100.00 |

MIPA—monoisopropylamine
TEOA—triethanolamine
AMP-95—95% 2-amino-2-methyl-1-propanol in an aqueous solution

The composition of Example 1 was a suspension concentrate and dispersed readily in spray water. The results of tests demonstrating the excellent stability of the composition are shown below in Table 3.

TABLE 3

| TEST | Standard/method | Interval | Result |
|---|---|---|---|
| Dispersion | CIPAC MT-160 | Ambient | 97.79 |
| Requirement > | | 1 wk 5 C | 97.19 |
| 95% dispersion | | 2 wk 54 C | 97.07 |
| | | 8 wk 40 C | 98.50 |
| | | 9 wk Cyclical | 98.14 |
| Assay | HPLC | Ambeint | 10.00 |
| Requirement < | | 1 wk 5 C | 9.94 |
| 2% deviation | | 2 wk 54 C | 9.89 |
| | | 8 wk 40 C | 10.28 |
| | | 9 wk CYC | 10.28 |
| Wet Sieve | CIPAC MT-185 | Ambient | 0.06 |
| Requirement < | | 1 wk 5 C | 0.00 |
| 0.1% total | | 2 wk 54 C | 0.02 |
| | | 8 wk 40 C | 0.04 |
| | | 9 wk Cyclical | 0.04 |
| Particle Size | Malvern, d90 | Ambient | 7.74 |
| Distribution | | 1 wk 5 C | 7.96 |
| Requirement < | | 2 wk 54 C | 7.61 |
| 12 micron | | 8 wk 40 C | 9.22 |
| post storage | | 9 wk Cyclical | 8.51 |

Efficacy—The efficacy of the composition of Example 1 was examined using the following procedure and provided the results shown in Table 5.

Title: Plant Growth Regulators in Kikuyugrass Turf Maintained as a Golf Course Fairway or Athletic Field.

Materials and Methods:

A trial was initiated at University of California-Riverside's Agricultural Operations Station comparing Anuew 27.5 WDG, NUP-19022, and Primo Maxx for growth regulation in kikuyugrass (Pennisetum clandestinum). The trial was conducted on a high-quality turf stand in a Hanford fine sandy loam. The trial area was mowed 3 days per week at 0.5 inches when growing during the trial period. The site was fertilized with 0.5 lb N per month and irrigated as necessary to avoid drought stress.

The trial had a randomized complete block design with 4 replications. Treatments were applied with a CO2 backpack sprayer with a spray volume application rate of 44 gallons per acre on 4 dates (A,C, E, and G) approximately 14 days apart: Jun. 25, 2020 (A), Jul. 9, 2020 (C), Jul. 23, 2020 (E), and Aug. 6, 2020 (G).

Evaluations consisted of visual turf quality, turf phytotoxicity, NDVI, DGCI, and clipping weights (fresh and dried). Data were analyzed using ANOVA and treatment means were separated using Fisher's LSD at the p 0.05 level.

TABLE 4
Treatment List:

| Treatment | | Rate | Application Timing |
|---|---|---|---|
| 1 | Untreated | | |
| 2 | Anuew 27.5 WDG | 12 oz/A | ACEG |
| 3 | Anuew 27.5 WDG | 24 oz/A | ACEG |
| 4 | Example 1 | 30 fl oz/A | ACEG |
| 5 | Example 1 | 60 fl oz/A | ACEG |
| 6 | Primo Maxx | 11 fl oz/A | ACEG |

TABLE 5
Clipping Weight Results
Clipping weight (fresh) [grams]

| | Treatment date (M/DD) | | | | | | | | | | | | | | | | |
|---|---|---|---|---|---|---|---|---|---|---|---|---|---|---|---|---|---|
| | 6/24 | 6/30 | | 7/7 | | 7/14 | | 7/21 | | 7/30 | | 8/4 | | 8/20 | | 8/28 | |
| 01 | 8.47 | 7.61 | a¹ | 6.09 | a | 3.96 | a | 5.22 | a | 2.09 | a | 1.94 | a | 5.99 | a | 9.84 | a |
| Untreated | | | | | | | | | | | | | | | | | |
| Control | | | | | | | | | | | | | | | | | |
| 02 | 7.24 | 3.51 | b | 2.24 | b | 0.82 | b | 0.73 | b | 0.47 | bc | 0.46 | b | 0.87 | b | 1.99 | b |
| Anuew | | | | | | | | | | | | | | | | | |
| (12 oz/A) | | | | | | | | | | | | | | | | | |
| 03 | 8.88 | 3.86 | b | 1.36 | b | 0.58 | b | 0.52 | b | 0.35 | bc | 0.37 | b | 0.74 | b | 1.74 | b |
| Anuew | | | | | | | | | | | | | | | | | |
| (24 oz/A) | | | | | | | | | | | | | | | | | |
| Example | 7.57 | 4.44 | b | 2.05 | b | 0.94 | b | 0.68 | b | 0.48 | bc | 0.47 | b | 1.24 | b | 2.56 | b |
| 1(30 oz/A) | | | | | | | | | | | | | | | | | |
| Example | 6.58 | 3.07 | b | 1.70 | b | 0.69 | b | 0.61 | b | 0.32 | c | 0.37 | b | 0.78 | b | 1.55 | b |
| 1(60 oz/A) | | | | | | | | | | | | | | | | | |
| 06 | 7.04 | 4.00 | b | 1.97 | b | 0.99 | b | 1.02 | b | 0.62 | b | 0.60 | b | 1.98 | b | 3.33 | b |
| Primo | | | | | | | | | | | | | | | | | |
| Maxx | | | | | | | | | | | | | | | | | |
| (11 oz/A) | | | | | | | | | | | | | | | | | |

| | | | | | | | | | |
|---|---|---|---|---|---|---|---|---|---|
| p-value^{†} | 0.7721 | 0.0002 | 0.0000 | 0.0000 | 0.0000 | 0.0000 | 0.0000 | 0.0000 | 0.0000 |

| | | | | | | | | | | | | | | | |
|---|---|---|---|---|---|---|---|---|---|---|---|---|---|---|---|
| 5 | DA-A² | 12 | DA-A | 5 | DA-C | 12 | DA-C | 7 | DA-E | 12 | DA-E | 17 | DA-G | 25 | DA-G |

^{†}A p-value ≥ 0.05 indicates a date on which there were no significant differences between treatments.
¹Means followed by differing letters within the same column are significantly different from each other (P = 0.05, LSD).
²Indicates number of days after (DA) the nearest application date (-A = 6/25, -C = 7/9, -E = 7/23, and -G = Aug. 6, 2020).

Anuew® plant growth regulator is an extruded granular plant growth regulator containing prohexadione-calcium (27.5 wt %) as the active available from Nufarm Americas

Primo Maxx® is a turf growth regulator containing trinexapac-ethyl as the active (120 g/L) as a microemulsion concentrate (available from Syngenta).

Clipping Weight Summary

Anuew 27.5 WDG, Example 1, and Primo Maxx all provided consistent growth regulation for the 2-month trial period providing statically fewer clippings than the untreated plots on every evaluation date after applications began. There was a predictable rate response with Anuew 27.15 WDG and Example 1 as the high rate provided numerically, though not statistically, increased growth regulation (fewer clippings collected) than the lower rates on 7 of 8 and 8 of 8 clipping evaluation dates after applications began, respectively.

This trial demonstrated the effective and consistent growth regulation of kikuyu grass with each PGR.

### Comparative Example 1

A composition much the same as that of Example 1 was prepared containing the components in the amounts shown in Table 6.

TABLE 6
Mill Base

| Component | Wt. % | Theo. (g) | Actual (g) | Act. Wt % |
|---|---|---|---|---|
| Water | 45.64 | 464.79 | 464.81 | 45.65 |
| AMS | 23.57 | 240.00 | 239.73 | 23.54 |
| Synergen GA | 5.89 | 60.00 | 59.98 | 5.89 |
| Propylene | 7.07 | 72.00 | 72.01 | 7.07 |
| glycol | | | | |
| Synergen GLS | 4.71 | 48.00 | 48.03 | 4.72 |
| Sag 1572 | 0.59 | 6.0 | 6.00 | 0.59 |
| Prohexadione- | 12.53 | 127.62 | 127.62 | 12.53 |
| Ca (94%) | | | | |
| Total | 100 | 1018.45 | — | — |

TABLE 7
Let Down

| Component | Theo. (g) | Actual (g) | Act wt % |
|---|---|---|---|
| Mill Base | 1018.45 | 943.69 | 84.83 |
| Kelzan gel | 155.15 | 155.43 | 13.97 |
| @ 2% | | | |
| SAG 1972 | 5.56 | 5.55 | 0.50 |
| Proxel BN | 4.45 | 4.45 | 0.40 |
| Water | | | |

The resulting pH neat was noted as 6.52. The HPLC data showed degradation.

### Comparative Example 2

A composition was prepared using the method of Comparative Example 1 using the following components in the amounts specified in Table 8.

TABLE 8

| Component | Wt. % | Theo. (g) | Actual (g) | Actual wt. % |
|---|---|---|---|---|
| Water | 43.85 | 447.85 | 447.87 | 54.1 |
| AMS | 23.50 | 240.00 | 239.99 | 29.02 |
| 45% KOH | 2.35 | 24.00 | 6.98 | 0.84 |
| Synergen GA | 5.87 | 48.00 | 60.00 | 7.26 |
| Propylene | 7.05 | 72.00 | 72.00 | 8.71 |
| glycol | | | | |
| Synergen GL5 | 4.70 | 48.00 | | 0.00 |
| SAG 1572 | 0.59 | 6.00 | | 0.00 |
| Prohexadione- | 11.81 | 120.60 | | 0.00 |
| Ca | | | | |
| Agromex ® | | 2.86 | | 0.00 |
| WG28 | | | | |
| Total | 99.72 | 1021.31 | 826.84 | 100.00 |

The pH after 3 days was noted as not stable. pH instability may be attributed to the residual sulfuric acid in AMS.

### Comparative Example 3

The composition of Comparative Example 3 (CE-3) was prepared by combining the components shown in the following table in the amounts by weight listed in Table 9.

TABLE 9

| Component | CE-3 Amount % w/w |
|---|---|
| Prohexadione-Ca | 10.67 |
| Ammonium Sulfate (AMS) | 20.06 |
| Synergen ® GL 5 | 4.01 |
| Synergen ® GA | 5.02 |
| Propylene glycol | 6.02 |
| Kelzan polysaccharide | 0.28 |
| Sag 1572 | 1.00 |
| Proxel ® BN | 0.40 |
| Sodium bicarbonate | 0.38 |
| Agromex ® WG 28 | 0.26 |
| water | 51.89 |
| TOTAL | 100.00 |

The resulting product was found to not be a viable product.

### Example 7

### Tank-Mix Compatibility

Prohexadione formulations are generally incompatible with many

Tank-mixing of the composition of the composition of Example 1 was examined with various commercially herbicides and compared with an existing prohexadione composition*.

TABLE 10

| Product | Active/s | Product Form |
|---|---|---|
| Rotator | Fluazinam: 3-chloro-N-[3-chloro-2,6-dinitro-4- | Suspension |
| | trifluoromethyl)phenyl]-5-trifluoromethyl-2- pyridinamine (CA) | concentrate |
| Traction | Fluazinam: 3-chloro-N-[3-chloro-2,6-dinitro-4-trifluoromethyl) | Suspension |
| | phenyl]-5-trifluoromethyl-2-pyridinamine (CA) | concentrate |
| | Tebuconazole: α-[2-(4-chlorophenyl)ethyl]-α-(1,1-dimethyl)-1H- | |
| | 1,2,4-triazole-1-ethanol | |
| Pinpoint | Mandestrobin: (RS)-2-methoxy-N-methyl-2-[alpha-(2,5- | Suspension |
| | xylyloxy)-o-tolyl]acetamide | concentrate |
| Arena 50 | Clothianidin: (E)-1-(2-chloro-1,3-Thiazol-5-ylmethyl)-3-methyl-2- | Wettable granule |
| WDG | nitroguanidine | |
| Aloft | Colthianidin:(E)-1-(2-chloro-1,3-Thiazol-5-ylmethyl)-3-methyl-2- | Suspension |
| | nitroguanidine | concentrate |
| | Bifentrhin: (2-methyl[1,1-biphenyl]-3-yl)methyl 3-(2-chloro-3,3,3 | |
| | trifluoro-1-propenyl)-2,2-dimethyl-cyclopropanecarboxylate | |
| Escalade 2 | 2,4-D: Dimethylamine salt 2,4-dichlorophenoxy acetic acid | Micro Emulsion |
| | Fluorowypyr: 1-methylheptyl ester of Fluroxypyr: (4-amino-3,5- | |
| | dichloro-6-fluoro-2-pyridinyl)oxy)acetic acid | |
| | Dicamba: 3,6 dichloro-o-anisic acid | |
| Celero | Imazosulfuron: 2-chloro-N-[(4,6-dimethoxy-2-pyrimidinyl)- | Wettable granule |
| | amino]carbonyl]imidazol[1,2-a]pyridine-3-sulfonamide | |
| Preference | non ionic adjuvant | liquid |
| Tourney | Metconazole: 5-[[4-chlorophenyl)methyl]-2,2-dimethyl-1-(1H- | Wettable granule |
| | l,2,4-triazol-1-ylmethyl)cylclopentaol | |
| Millenium | 2,4-D: Dimethylamine salt of 2,4-dichlorophenoxy acetic acid | Soluble liquid |
| Ultra 2 | Clopyralid: Monoethanolamine salt of 3,6 dichloro-2- | |
| | pyridinecarboxylic acid | |
| | Dicamba: Dimethylamine salt of 2,4-dichloro-o-anisic acid | |
| Prosedge | Halosufuron-methyl | wettable granule |
| Phostrol | mono-and dibasic sodium, potassium, and ammonium phosphites | Soluble Liquid |

The comparison was made with ANUEW® brand granular composition of 27.5 wt % prohexadione-calcium which was not compatible with the above tank mix partners.

### Example 8

### Prohexadione Suspension Concentrate

Some water sources when combined prohexadione-calcium may give rise to formation of precipitates. We have found that chelating agents, particularly MGDA, are useful in inhibiting the formation of crystalline material during or after preparation of the suspension concentrate and improve the product in different quality water.

A composition of the invention was prepared with Dissolvine®-M composition of MGBA having the composition set out in Table 11.

TABLE 11
Theoretical Composition

| Description | Parts by weight |
|---|---|
| Dionized Water | 33.67% |
| AMS | 20.00% |
| Triethanol amine | 4.00% |
| (DI Hole to bring pH to 9.5) | 2.50% |
| Synergen GA | 5.00% |
| propylene glycol | 6.00% |
| Synergen GL 5 | 4.00% |
| Kelzan | 0.28% |
| SAG 1572 | 1.00% |
| Proxel BN | 0.40% |
| Dissolvine M | 3.00% |
| Prohexadione Ca | 10.64% |
| WG28 | 0.26% |
| Total | 90.75% |

Dissolvine®-M is a product of Nouryon of The Netherlands containing approx. 40 wt % trisodium salt of methylglycine diacetic acid (MGDA-Na3) in water.

TABLE 12
Mill Base

| Description | Theo. (g) | Actual | pH |
|---|---|---|---|
| DI Water | 905.34 | 905.34 | 6.5 |
| AMS | 625.00 | 625.00 | 4.25 |
| Triethanol | 125.00 | 125.00 | |
| amine | | | |
| TEAOH hole | 78.13 | | |
| synergen GA | 156.25 | 156.25 | |
| propylene | 187.50 | 187.50 | |
| glycol | | | |
| Synergen GL | 125.00 | 125.00 | |
| 5 | | | |
| SAG 1572 | 31.25 | 31.25 | |
| Dissolvine M | 12.50 | | |
| Hole | | | |
| Prohexadione | 332.50 | 332.50 | |
| Ca | | | |
| WG 28 | 8.13 | 8.13 | |
| Totals | 2586.59 | 2495.97 | |
| | Recovery | 2495.97 | |
| | % Recovery | 100.00% | |

Two Compositions were prepared, Compositions A and B differing in the addition of the chelating agent

TABLE 13
Let Down A

| Description | Act. % w/w |
|---|---|
| Mill Base | 79.87% |
| Kelzan gel @ 2.0% | 14.72% |
| proxel BN | 0.42% |
| Triethanol amine | 1.28% |
| DI water | 0.04 |
| | 100.00% |

Composition A

| Description | % w/w | Al content |
|---|---|---|
| Deionized Water | 47.11% | |
| AMS | 20.00% | |
| Triethanol amine | 5.28% | |
| Synergen GA | 5.00% | |
| propylene glycol | 6.00% | |
| Synergen GL 5 | 4.00% | |
| SAG 1572 | 1.00% | |
| Prohexadione Ca | 10.64% | 10.00% |
| WG28 | 0.26% | |
| Kelzan | 0.29% | |
| Proxel BN | 0.42% | |
| TOTALS | 100.00% | |

Let Down B

| Description | Act. % w/w |
|---|---|
| Mill Base | 79.83% |
| Kelzan gel @ 2.0% | 14.71% |
| Dissolvine M | 2.99% |
| proxel BN | 0.42% |
| Triethanol amine | 1.28% |
| DI water | 0.77% |
| | 100.00% |

Composition B

| Description | % w/w | Al content |
|---|---|---|
| Deionized | 44.16% | |
| AMS | 20.00% | |
| Triethanol | 5.28% | |
| Synergen GA | 5.00% | |
| propylene glycol | 6.00% | |
| Synergen GL 5 | 4.00% | |
| SAG 1572 | 1.00% | |
| Prohexadione | 10.64% | 10.00% |
| WG28 | 0.26% | |
| Kelzan | 0.29% | |
| Dissolvine M | 3.00% | |
| Proxel BN | 0.42% | |
| TOTALS | 100.05 | |

Both compositions proved stable.

1. An aqueous suspension concentrate composition of prohexadione comprising prohexadione-calcium, ammonium sulfate and an amine.

2. The aqueous suspension concentrate composition of claim 1, wherein the amine has a water solubility of at least 4 g/L at 20° C.

3. The aqueous suspension concentrate composition of claim 1 wherein the amine comprises at least one of formula (I) 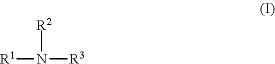
wherein R¹, R² and R³ are independently selected from the group consisting of hydrogen, C₁ to C₆ alkyl; aryl; C₁ to C₆ alkyl substituted with a substituent selected from the group consisting of hydroxyl, C₁ to C₆ alkoxy, amino, C₁ to C₆ alkylamino, amino-substituted alkylamino, amino-substituted C₁ to C₆ alkoxy and di-(C₁ to C₆ alkyl)amino;
and wherein at least one of R₁, R₂ and R₃ is other than hydrogen; and the group wherein two of R¹, R² and R³ together form a ring, incorporating the amine nitrogen, of 5 or 6 constituent ring members selected from the group consisting of methylene and optionally a further heteroatom ring member (in addition to the amine nitrogen) selected from —O—, oxo (C═O), —N(H)— and —N(C₁ to C₆-alkyl)-; and the other of R¹, R² and R³ is selected from hydrogen, C₁ to C₆ alkyl and C₁ to C₆ alkyl substituted with a substituent selected from the group consisting of hydroxyl, C₁ to C₆ alkoxy, amino and (C₁ to C₆ alkyl)amino.

4. The aqueous suspension concentrate composition of claim 3 wherein in formula I the groups R¹, R² and R³ are independently selected from the group consisting of hydrogen, C₁ to C₆ alkyl; C₁ to C₆ alkyl substituted with a substituent selected from the group consisting of hydroxyl, C₁ to C₆ alkoxy, amino, C₁ to C₆ alkylamino, amino substituted alkylamino, amino substituted C₁ to C₆ alkoxy and di-(C₁ to C₆ alkyl)amino; and wherein at least one of R₁, R₂ and R₃ is other than hydrogen.

5. The aqueous suspension concentrate composition of claim 3 wherein, in formula I the groups R¹, R² and R³ are independently selected from the group consisting of hydrogen, C₁ to C₆ alkyl; C₁ to C₆ alkyl substituted with a substituent selected from the group consisting of hydroxyl, C₁ to C₆ alkoxy, amino, C₁ to C₆ alkylamino, amino-substituted alkylamino, amino substituted C₁ to C₆ alkoxy and di-(C₁ to C₆ alkyl)amino; and wherein at least one of R1, R2 and R3 is other than hydrogen.

6. The aqueous suspension concentrate composition of claim 1, wherein the amine is selected from the group consisting of ethanolamine, dimethyl ethanolamine di-ethanolamine, di-isopropanolamine, tri-ethanolamine, tri-isopropanolamine, ethylenediamine, morpholine and 2-amino-2-methyl-1-propanol.

7. The aqueous suspension concentrate composition of claim 1, wherein the tertiary amine is triethanolamine or triisopropanolamine.

8. The aqueous suspension concentrate composition of claim 1 wherein prohexadione-calcium is present in an amount of at least 5 wt %.

9. The aqueous suspension concentrate composition of claim 1, wherein prohexadione-calcium is present in an amount of such as 5 wt % to 20 wt % of the composition.

10. The aqueous suspension concentrate composition of claim 1, wherein the weight ratio of ammonium sulfate to prohexadione-calcium is from 3:1 to 1:1.

11. The aqueous suspension concentrate composition of claim 1, wherein the amine is present in the composition in an amount to provide a pH of the composition in the range of 7.5 to 9.5, preferably in the range of 7.5 to 9 such as 7.8 to 9.0, 7.8 to 8.5 and most preferably about 8.

12. The aqueous suspension concentrate composition of claim 1, wherein the amine is present in an amount in the range of 1 wt % to 10 wt % of the composition.

13. The aqueous suspension concentrate composition of claim 1 , wherein the amine is present in an amount in the range of 0.5 wt % to 5 wt % of the composition.

14. The aqueous suspension concentrate composition of claim 1, wherein the composition comprises:
5 wt % to 15 wt % prohexadione-calcium;
a weight ratio of ammonium sulfate to prohexadione sulfate in the range of 6:1 to 1:1; and
a non-volatile tertiary amine in an amount of from 0.5 wt % to 5 wt %.

15. The aqueous suspension concentrate composition of claim 1, wherein the composition comprises:
7 wt % to 15 wt % prohexadione-calcium;
15 wt % to 30 wt % ammonium sulfate;
0.5 wt % to 5 wt % amine, preferably triethanolamine; and
2 wt % to 20 wt % surfactants.

16. The aqueous suspension concentrate composition of claim 1, wherein the composition comprises a surfactant selected from the group consisting of organosilicones, alkylpolyoxyethylene ethers, alkylphenol ethoxylate and alcohol alkoxylate surfactants; fatty acid, fatty ester and fatty amine ethoxylates, sorbitan and ethoxylated sorbitan esters; ethoxylated vegetable oils, alkyl, glycol and glycerol esters and glycol ethers; tristyrylphenol ethoxylates; copolymers of glycerol, a dicarboxylic acid and a monocarboxylic acid; and glucamides.

17. The aqueous suspension concentrate composition of claim 1, wherein the composition comprises a surfactant which is a copolymer of glycerol, phthalic acid anhydride and coconut fatty acid.

18. The aqueous suspension concentrate composition of claim 1, wherein the composition comprises a surfactant comprises a non-ionic wetting agent.

19. The aqueous suspension concentrate composition of claim 15, wherein the composition comprises a surfactant which is a wetting agent selected from glucamides.

20. The aqueous suspension concentrate composition of claim 15, wherein the surfactant composition comprises a capryloyl/caproyl methyl glucamide.

21. The aqueous suspension concentrate composition of claim 1, wherein the composition contains 0.5 wt % to 10 wt % such as 0.5 wt % to 5 wt % copolymers of glycerol, a dicarboxylic acid and a monocarboxylic acid.

22. The aqueous suspension concentrate composition of claim 1, wherein the surfactant composition comprises 0.5 to 10 wt % of the aqueous suspension concentrate composition of glucamide surfactant.

23. The aqueous suspension concentrate composition of claim 1, comprising:
5 wt % to 15 wt % prohexadione-calcium;
10 wt % to 30 wt % ammonium sulfate;
0.5 wt % to 5 wt % amine, preferably triethanolamine; and
0.5 wt % to 10 wt % such as 0.5 wt % to 5 wt % surfactant which is a copolymer of glycerol, a dicarboxylic acid and a monocarboxylic acid; and
0.5 wt % to 10 wt % glucamide surfactant such as 0.5 wt % to 5 wt % glucamide surfactant.

24. The composition of claim 1 comprising propylene glycol antifreeze in an amount of 1 wt % to 10 wt %.

25. A method of regulating the growth of plants comprising foliar application of the composition of claim 1, optionally following dilution.

26. The method of claim 25 wherein the plants are selected from the group consisting of fruit trees (especially apple, pear and sweet cherry), gramineae (in particular wheat, triticella, barley, oats and rye, but also maize, rice, sugarcane and turf grass). cotton, soybeans, millet, sunflowers, oilseed rape, peanuts, coffee, rice, ornamental plants, lawn grasses (such as Kentucky bluegrass, annual and perennial Ryegras, Tall Fescue, red fescue, white ostrich grass, annual Bluegrass, Zoysia, Bermude, Centopide, St. Augustine).

27. The method of claim 25 wherein the aqueous composition is diluted with water prior to foliar spray application and sprayed onto target plants at a concentration of 50 ppm ai to 1000 ppm.
